(19) United States
(12) Patent Application Publication
(10) Pub. No.: US 2008/0248315 A1
(43) Pub. Date: Oct. 9, 2008

(54) Photochromic Laminate of Glass and Polyvinyl Butyral Resin

(76) Inventor: Ronald C. Wiand, Troy, MI (US)

Correspondence Address: RONALD L. HOFER, 122 LINDBERGH LANE, MOORESVILLE, NC, 28117, US

(21) Appl. No.: 11/883,866

(22) PCT Filed: Feb. 7, 2006
(86) PCT No.: PCT/US06/04293

§ 371 Date: Aug. 7, 2007

Related U.S. Application Data
(60) Provisional application No. 60/651,134, filed on Feb. 8, 2005.

(51) Int. Cl. B32B 17/10

(52) U.S. Cl. 428/425.3; 428/437

(57) ABSTRACT

A laminate has first and second layers of glass between which are sandwiched first and second layers of polyvinyl butyral resin wherein the first polyvinyl butyral resin layer consists essentially of polyvinyl butyral resin and an ultraviolet absorber and the second polyvinyl butyral resin layer consists essentially of a polyvinyl butyral resin, a photochromic moiety and a free radical inhibitor

### BACKGROUND OF THE INVENTION

The present invention relates to transparent or semi-transparent laminates having a photochromic feature. More specifically, the present invention relates to transparent or semi-transparent laminates of glass and sheets of polyvinyl butyral resin containing a photochromic moeity.

Polyvinyl butyral resin is used in the construction of automotive glass laminates. In a conventional automotive glass process, a layer of polyvinyl butyral resin is bonded together between two panes of glass under heat and pressure. The glass sandwich appears to be one layer of glass. However, if one glass layer of the sandwich cracks or breaks upon impact, the glass fragments will tend to adhere to the layer of polyvinyl butyral resin. The laminated structure thus improves safety as well as offering other benefits such as noise reduction, ultraviolet screening and security.

The present invention relates to a method and product by which a laminate of glass and polyvinyl butyral resin is provided with a photochromic feature. Although tinted automotive glass has become popular and is well known throughout the world, tinted glass suffers from the disadvantage that the windows are consistently tinted during both day and night. Tinted windows may interfere with visibility during hours of darkness. Thus, it would be advantageous to have automotive windows which were desirably tinted during hours of bright sunshine and yet not tinted during hours of darkness, at least not to an extent that would interfere with good visibility from inside of the automobile.

Photochromic tinting offers one method for providing tinting in bright sunshine but not in the dark. However, photochromic tinting encounters some of its own problems when applied to automotive uses. One particular problem is that the life of photochromic moeities is relatively short and may not be suited for automotive uses which require relatively long life cycles. Another problem is that the photochromic moieties must be provided in a matrix which is suitable for automotive uses. For example, a driver going from conditions of bright sunlight to conditions inside a tunnel requires a tint which can relatively quickly adjust to the lower lighting conditions. Also, the photochromic moiety must be carried in a matrix which facilitates relatively long life for the moiety.

While the above background description and the following description of the present invention are set forth generally in terms of automotive glass laminates, it should be appreciated that the scope of the present invention is broader than automotive glass and that variations and modifications of this invention will be readily apparent to those skilled in the art. Further understanding of the present invention will be had from the following specification taken in conjunction with the accompanying drawings.

### SUMMARY OF THE INVENTION

A preferred embodiment of the invention is a laminate having first and second layers of glass between which is sandwiched first and second layers of polyvinyl butyral resin. The first polyvinyl butyral resin layer consists essentially of polyvinyl butyral resin and an ultraviolet absorber. The second polyvinyl butyral resin layer consists essentially of a polyvinyl butyral resin, a photochromic moiety and a free radical inhibitor. In another preferred embodiment of the present invention, a layer of polyester or polyurethane is sandwiched between the first and second layers of polyvinyl butyral resin which are as described above and which are in turn sandwiched between first and second layers of glass.

### BRIEF DESCRIPTION OF THE DRAWINGS

FIG. 1 shows a cross-sectional view, broken away, of a preferred laminate of the present invention; and

FIG. 2 shows a cross-sectional view, broken away, similar to that of FIG. 1 but of an alternative preferred embodiment of the present invention.

### DESCRIPTION OF THE PREFERRED EMBODIMENTS

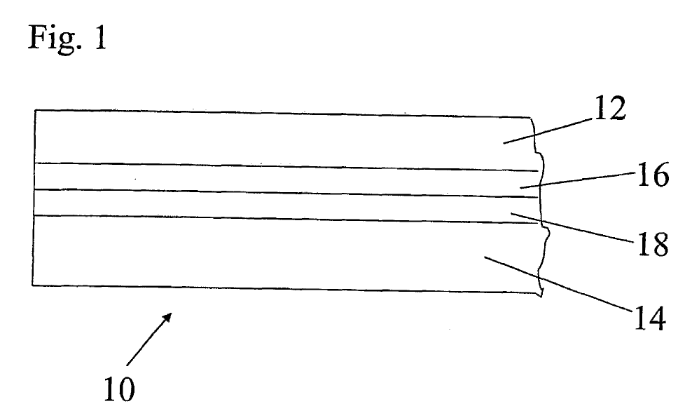

Now referring to FIG. 1, a preferred laminate of the present invention is illustrated and indicated generally by the numeral 10. Laminate 10 has first glass layer 12 and second glass layer 14 between which are sandwiched respective first and second polyvinyl butyral resin layers 16 and 18. It is contemplated that one of resin layers 16 and 18 will consist essentially of a photochromic moiety and one or more free radical inhibitors while the other of resin layers 16 and 18 will consist essentially of polyvinyl butyral resin and one or more ultraviolet absorbers.

It has been found that ultraviolet (uv) absorbers have a negative effect on the life of photochromic moieties. Yet uv absorbers are necessary to obtain a reasonable life for resins such as polyvinyl butyral resins. Similarly, free radical inhibitors are required for satisfactory life of the photochromic moiety. By providing two discrete layers of polyvinyl butyral resin with one containing the uv absorber and the other containing the photochromic moeity and the free radical inhibitor, a good life is obtained for the photochromic moiety as well as for the polyvinyl butyral resin.

Suitable glass for use in the present invention include all varieties of glass so long as the glass is suitable for its intended end use. Automotive glasses are especially contemplated for use herein.

Suitable polyvinyl butyral resins include those commonly used in the automotive industry for automotive glass laminates and are commercially available from, for example, Solutia, which markets suitable polyvinyl butyral resins under the brand “Saflex.”

Suitable uv absorbers work by absorbing ultraviolet radiation and converting the radiation into thermal energy through tautomerism. Of course, the selected uv absorber must not substantially absorb the range of uv light required to activate the photochromic moiety. Examples of suitable uv absorbers include Cyasorb VV-9 and UV 531, Cyaguard UV 1164 and 1084 from American Cyanamid, Sanduvor VSU from Sandoz/Clariant, Uvinul 3035 from BASF, Tinuvin 328 and P and Irgastab 2002 from Ciba Geigy, Rylex NBC from Dupont, UV Chek AM 101, 105, 126, and 205 from Ferro Corp and Carstab 700 from Morton International.

Suitable free radical inhibitors include hindered amine light stabilizers or HALS as well as antioxidants. Examples of HALS include Sanduvor 3051, 3052, 3055, 3056 from Sandoz/Clariant, Tinuvin 770, 765, 144, 622 from Ciba Geigy, Cyasorb 3346 from American Cyanamid. Examples of antioxidants include Irganox 3114 from Ciba Geigy.

Suitable photochromic moieties are well-known in the art and include those selected from the group consisting of anthraquinones, naphtopyrans, phhalocyanines, spiro-oxazines, chromenes, pyrans including spiro-pyrans and fulgides. Suitable photochromic molecules include but are not limited to those disclosed in U.S. Pat. Nos. 5,882,556 Mar. 16, 1999 to Perrott et al. which is specifically incorporated by reference herein. Reversacal photochromic dyes commercially available from James Robinson are particularly suitable for use herein. In addition to photochromic molecules, the photochromic composition may include a non-photochromic dye if it is desired to provide a tint to the lens even when the photochromic molecules are not activated.

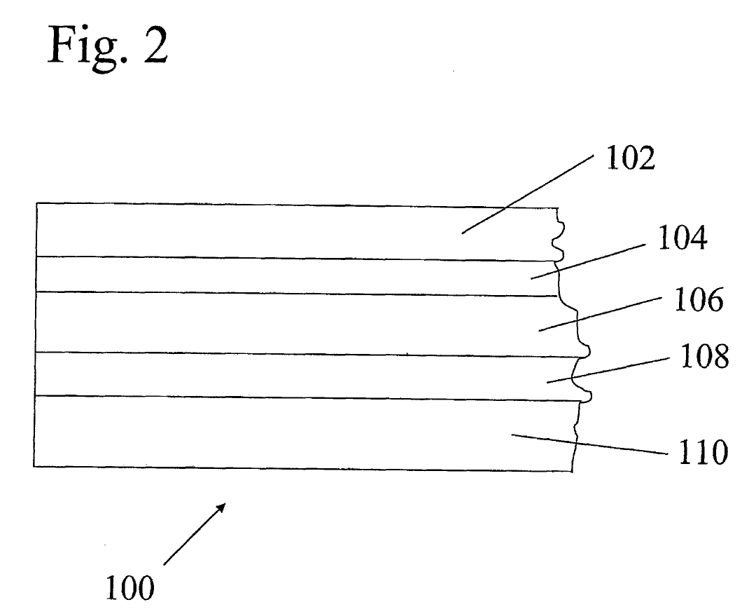

Now referring to FIG. 2, an alternative preferred laminate of the present invention is shown and indicated generally by the numeral 100. Laminate 100 has first glass layer 102 and second glass layer 110 between which is sandwiched a tri-laminate of polyvinal butyral resin layers 104 and 108 with layer 106 therebetween comprising a resin film selected from the group consisting of polyethylene terephthalate (PET) and polyurethane. It is contemplated that on of polyvinal butyral resin layers 104 and 108 will consist essentially of a photochromic moiety and one or more free radical inhibitors while the other of resin layers 104 and 108 will consist essentially of polyvinyl butyral resin and one or more ultraviolet absorbers.

Further understanding of the present invention will be had from the following examples.

### Example 1

A first sheet of PVB is extruded with a normal automotive formulation containing uv absorbers that is approximately 6 inches by 54 inches and 0.0125 inches in thickness. A second sheet of 0.015 inch thick by 6 inches by 54 inches PVB is extruded with 0.004% by weight Corn Yellow photochromic dye from Keystone Aniline and 0.4% by weight irganox 1010.

The two sheets of PVB were laminated together to form one 0.030 inch thick sheet. When the side of the laminated PVB containing the photochromic molecule is exposed to uv light the PVB exhibits yellow color. If the uv light is allowed to radiate the side of the PVB that has the uv absorber in it, no activation of the photochromic dye is noted.

The PVB is then used to laminate two pates of glass together. When the side of the glass that has the photochromic side of the PVB laminated to it is exposed to uv light, it shows a yellow color.

### Example 2

Two sheets of PVB that are 0.015 inches thick are prepared. One of the sheets has uv absorbers in it and the second sheet does not contain uv absorbers. A film of PET is extruded with Palatinate Purple photochromic dye from Keystone Aniline. The PET sheet turns a blue color when exposed to uv light and turns transparent when the uv exposure is terminated.

The PET sheet is laminated between two sheets of PVB, one of which contains an uv absorber and the resulting laminate is then used to laminate two flat pieces of tempered glass. As in Example 1, the glass laminate changes color when the side of glass that has the PVB without uv absorber exposed to a uv light source.

### Example 3

A sheet of PVB that is 12 inches square is mad into a color changing laminate by spraying 50 cc of IPA onto one side of it. The 50 cc of IPA contains 25 mg. of Berry Red photochromic dye dissolved therein. The photochromic treated PVB is then laminated between two pieces of tempered glass using a normal laminating cycle. The result is an assembly that exhibits a color change when the side of the glass that has the PVB with photochromic dye sprayed onto it is exposed to uv light.

What is claimed is:

1. A laminate having first and second layers of glass between which are sandwiched first and second layers of polyvinyl butyral resin wherein the first polyvinyl butyral resin layer consists essentially of polyvinyl butyral resin and an ultraviolet absorber and the second polyvinyl butyral resin layer consists essentially of a polyvinyl butyral resin, a photochromic moiety and a free radical inhibitor.

2. A laminate as in claim 1 wherein a layer selected from the group consisting of polyester, PET or polyurethane is sandwiched between the first and second layers of polyvinyl butyral resin.
